(19) United States
(12) Patent Application Publication
(10) Pub. No.: US 2019/0392721 A1
(43) Pub. Date: Dec. 26, 2019

(54) EDUCATIONAL APPARATUS

(71) Applicant: Konesans, LLC, Philadelphia, PA (US)

(72) Inventor: Jacques Louis, Philadelphia, PA (US)

(21) Appl. No.: 16/447,303

(22) Filed: Jun. 20, 2019

Related U.S. Application Data
(60) Provisional application No. 62/687,420, filed on Jun. 20, 2018.

(51) Int. Cl. G09B 5/02; G09B 23/02; A63H 33/04

(52) U.S. Cl. CPC G09B 5/02; A63H 33/04; G09B 23/02

(57) ABSTRACT

A kit defines an educational apparatus and includes multiple blocks. At least some of the blocks have a length equal to a unit length multiplied by an integer from 1 to 10, and includes, for each length equal to an integer from 1 to 10 multiplied by the unit length, at least one block. The blocks bear indicia identifying the integer corresponding to the length of the block.

### CROSS-REFERENCE TO RELATED APPLICATION

The present application claims, under 35 U.S.C. 119(e), benefit of, and priority to, U.S. Provisional Patent Application Ser. No. 62/687,420, filed Jun. 20, 2018, which application is incorporated herein in its entirety for all purposes.

### FIELD OF INVENTION

The present disclosure is in the field of educational apparatuses, particularly those for use in teaching mathematical skills and concepts.

### BACKGROUND

In education in connection with basic math concepts, such as learning basic addition, subtraction and multiplication, there has traditionally been a dependence on memorization. Children may be guided to repeat and rewrite such basic mathematical facts to spur memorization. However, memorization of addition and subtraction facts and multiplication tables is difficult for children, and may not promote comprehension of underlying concepts.

Educational techniques that employ active engagement of children in learning, and self-initiated development of knowledge and understanding, have been shown to be more effective than rote memorization. Techniques and apparatuses that promote learning of mathematical concepts via active engagement are desirable.

### SUMMARY

In an embodiment, a kit defines an educational apparatus and includes multiple blocks. At least some of the blocks have a length equal to a unit length multiplied by an integer from 1 to 10, and includes, for each length equal to an integer from 1 to 10 multiplied by the unit length, at least one block. At least some of the blocks, and in an embodiment, each of the blocks, has indicia identifying the integer corresponding to the length of the block.

In an embodiment, a non-transitory computer-readable medium stores an application program including processor executable instructions, which instructions, when executed by the processor, cause the processor to display, on an interactive user interface, a plurality of blocks, at least some of the blocks having a length equal to a unit length multiplied by an integer from 1 to 10, and comprising, for each length equal to an integer from 1 to 10 multiplied by the unit length, at least one block; and responsive to user input, move the blocks on the interactive user interface. Each of the blocks has indicia thereon corresponding to the integer defining the length of the block in unit lengths.

### BRIEF DESCRIPTION OF THE DRAWINGS

FIG. 1 is a perspective view of a set of blocks according to an embodiment.

FIGS. 2A-2D are end views of blocks according to an embodiment.

FIG. 3 is a perspective view of a set of blocks, similar to the embodiment of FIG. 1.

FIG. 4 is a view of a set of blocks defining operations for use in an embodiment.

FIG. 5 is a schematic view showing blocks according to an embodiment used for illustrating comparisons.

FIG. 6 is a schematic view showing blocks according to an embodiment used for illustrating addition, employing blocks illustrated with operation symbols.

FIG. 7 is a schematic view showing blocks according to an embodiment used for illustrating addition.

FIG. 8 is a schematic view showing blocks according to an embodiment used for illustrating subtraction, employing blocks illustrated with operation symbols.

FIG. 9 is a schematic view showing blocks according to an embodiment used for illustrating subtraction

FIG. 10 is a schematic view showing blocks according to an embodiment used for illustrating multiplication by 9.

FIG. 11 is a schematic view showing blocks according to an embodiment used for illustrating multiplication by 7

FIG. 12 is a view of blocks arranged to illustrate the Pythagorean theorem.

FIG. 13 illustrates an embodiment in which the blocks are digital images shown on a display of a device.

FIGS. 14A, 14B, 14C and 14D are views of blocks according to embodiments arranged to aid in understanding of geometric concepts.

FIG. 15 is a view of an exemplary block showing unit-sized markings.

FIG. 16 is a block diagram of a computer system for running a program in accordance with an embodiment.

### DETAILED DESCRIPTION

Conventional details of apparatuses known to those of ordinary skill in the art are not shown. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

In embodiments, a kit includes blocks. At least some of the blocks have a length corresponding to a unit length multiplied by an integer from 1 to 10. The kit may include at least ten such blocks. Each block may have indicia thereon indicating the integer corresponding to the length of the block.

A “block” as used herein means a solid object that maintains its shape. A block has a fixed length. Blocks of a kit are preferably in equal sizes in dimensions other than length. For example, blocks of a kit may all have a same cross section taken perpendicular to their long axes. The ends of blocks may be configured to about one another; for example, the ends of blocks may be planar and lying in a plane perpendicular to a long axis of the block.

The embodiments described herein are solely for the purpose of illustration. Those in the art will recognize that other embodiments may be practiced with modifications and alterations.

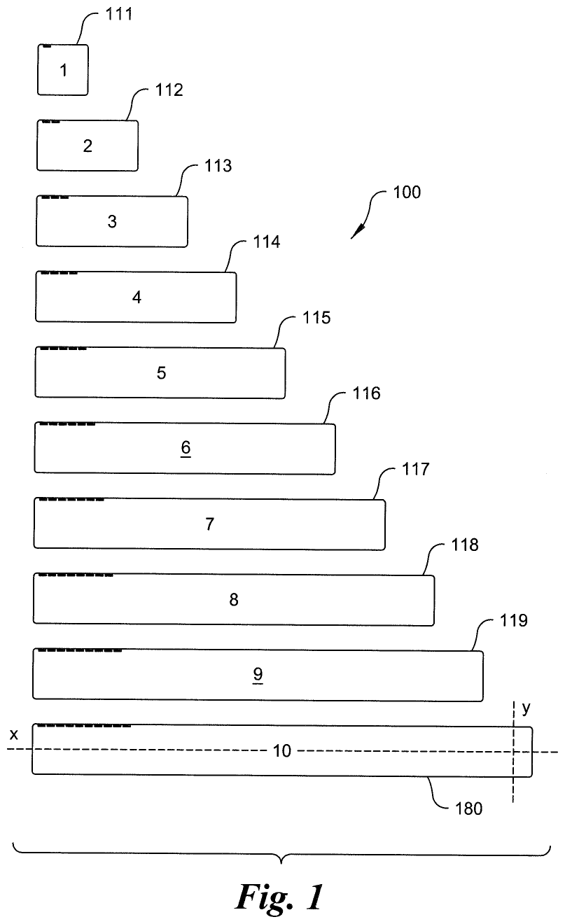

Referring to FIG. 1, an exemplary kit 100 is shown. Kit 100 includes blocks 111-119 and 180 having lengths, measured along a main axis of each block, corresponding to a unit length multiplied by each integer from 1 to 10. Each block is in the form of a rectangular prism, or substantially in the form of a rectangular prism, such as having rounded edges and corners. Block 180, which is 10 units in length, has illustrated thereon an x-axis, which is a main axis, and the axis along which the length of the blocks vary. The illustrated y-axis is perpendicular to the x-axis. All blocks may be of the same dimension in the y-axis, as well as in a depth axis perpendicular to both the x and y axes. In an embodiment, kit 100 includes only blocks having lengths corresponding to a unit length multiplied by each integer from 1 to 10. Each block has thereon indicia 120, 122 of the integer corresponding to the length of the block. The indicia may be visible indicia, in the form of numerals 120, or tactile indicia, in the form of grooves 122 defined in a surface of the block. Thus, block 111 is 1 unit in length, bears the numeral 1, and has a single groove. Block 112 is 2 units in length, bears the numeral 2, and has two grooves. Block 113 is 3 units in length, bears the numeral 3, and has 3 grooves. Block 114 is 4 units in length, bears the numeral 4, and has 4 grooves. Block 115 is 5 units in length, bears the numeral 5, and has 5 grooves. Block 116 is 6 units in length, bears the numeral 6, and has 6 grooves. Block 117 is 7 units in length, bears the numeral 7, and has 7 grooves. Block 118 is 8 units in length, bears the numeral 8, and has 8 grooves. Block 119 is 9 units in length, bears the numeral 9, and has 9 grooves. Block 180 is 10 units in length, bears the numeral 10, and has 10 grooves.

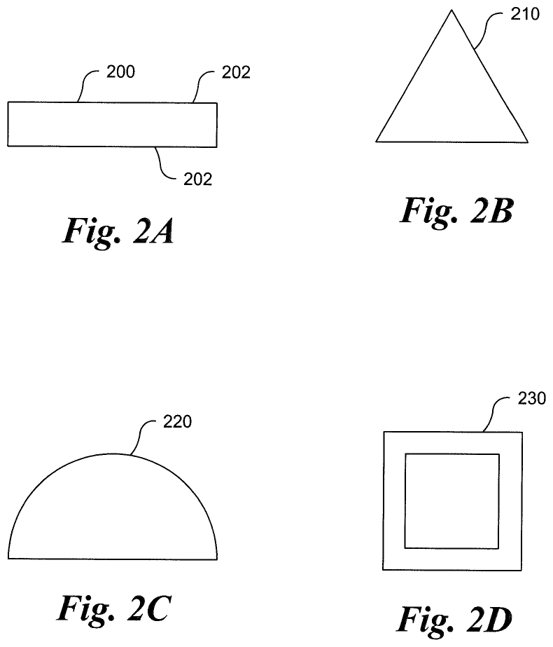

Each block may be configured to rest on a planar surface, such as a table or floor. Each block thus preferably has a planar surface extending along its long axis. Referring to FIGS. 2A, 2B, 2C and 2D are exemplary end views of blocks, showing cross-sections. In FIG. 2A, an end view of a block 200 having a rectangular cross-section is shown. Block 200 thus has planar, parallel, opposing wide sides 202, and may easily rest on either of those sides. Indicia in the form of numerals may be provided on each of the wide sides.

In FIG. 2B, an end view of a block 210 having a triangular cross-section is shown. Block 210 may rest on any of its sides, and visible and tactile indicia may be provided on each of the sides or fewer of the sides.

In FIG. 2C, an end view of a block 220 having a single planar side and an opposing curved surface, which may define a section of a cylinder, is shown. The block 220 may rest on its planar side, and may have indicia on its curved surface.

In FIG. 2D, an end view of a block 230 having four walls surrounding a hollow chamber, open at one end, is shown. Indicia may be on the outside surfaces of the walls.

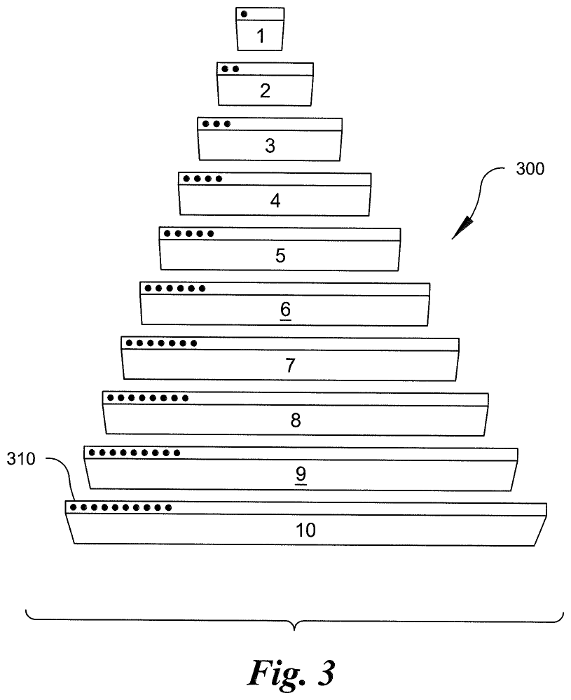

Referring to FIG. 3, a perspective view of blocks 300, similar to the blocks of FIG. 1, is shown. Blocks 300 have wells 310 defined therein to serve as tactile indicia, the number of wells corresponding to the number of units of length of the blocks. The wells may be valuable for children having reduced vision. Other tactile indicators, such as bumps protruding from a surface, ribs protruding from a surface, and grooves defined in a surface, may be employed. Multiple sets of tactile indicators indicating length of the block in units may be provided on a single block. By way of example, sets of tactile indicators may be provided on both narrow sides of a block having a cross-section as illustrated in FIG. 2A, so that the tactile indicators may be felt when the blocks are held in any orientation.

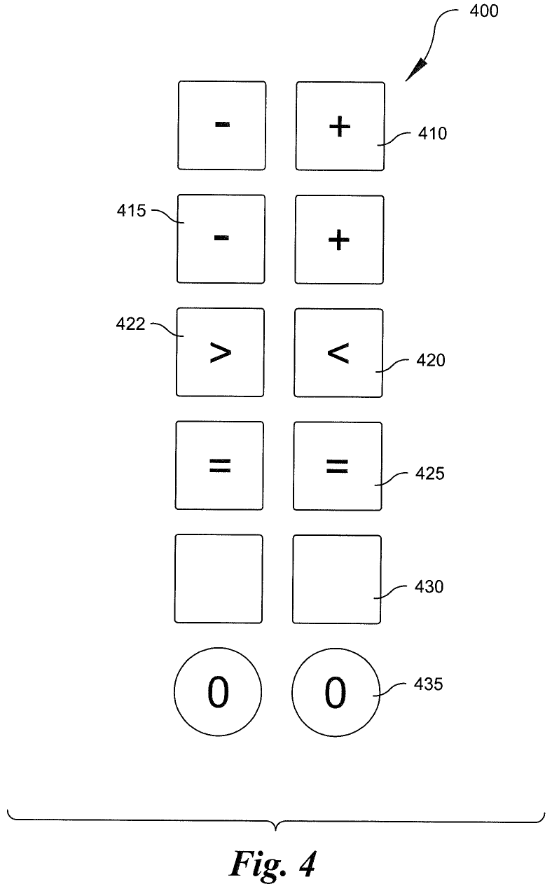

FIG. 4 is a view of a set of blocks defining operations for use in an embodiment. Block 410 is illustrated with a plus symbol. Block 415 is illustrated with a minus symbol. Block 420 is illustrated with a less than sign, and block 422 is illustrated with a greater than sign. Block 425 is illustrated with an equality operator. Block 430 is a blank block, which may be one unit on two of its sides. Block 435 is a 0 block.

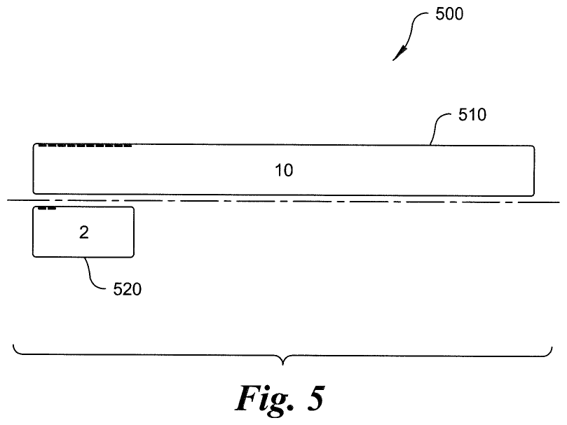

FIG. 5 illustrates the use of blocks for comparison. By placing block 510, of 10 units in length, adjacent block 520, of 2 units in length, adjacent one another, a child may obtain an understanding of relative sizes of the integers 10 and 2.

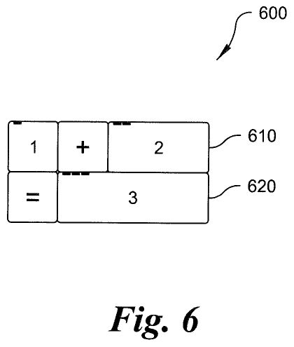

FIG. 6 illustrates the use of blocks for illustrating addition. In arrangement 600, the top row 610 shows two blocks corresponding to two integers, and a block for the addition operation. The bottom row 620 shows a block corresponding in length to a sum of the integers in the top row, along with a block for the equality operator/equals sign. By using blocks of equal size to one another for addition and equality operators, the child may readily grasp the meaning of the addition process. The child may select blocks of other lengths to readily understand the addition of other integral numbers, and may easily compare blocks of varying lengths to obtain a concept of which integers sum to which other integers, and which do not sum.

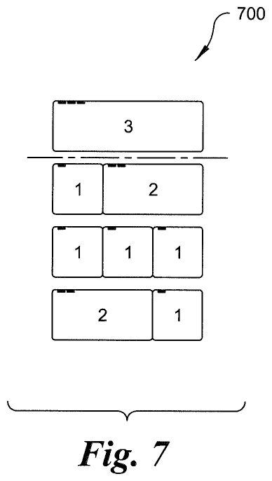

FIG. 7 also illustrates the use of blocks for illustrating addition, and in particular in illustrating options to obtain a sum. In the top row of arrangement 700, a block having 3 units in length is shown. In the second row, two blocks, 1 unit and 2 units in length, from left to right, are shown, illustrating that 1+2=3. In the third row, three blocks, each 1 unit in length, are shown, illustrating that 1+1+1=3. In the fourth row, two blocks, 2 and 1 units in length, from left to right, are shown, thus illustrating that 2+1=3, and further illustrating that 1+2=2+1. Again, a child may select blocks of other lengths to gain understanding of the concept of addition.

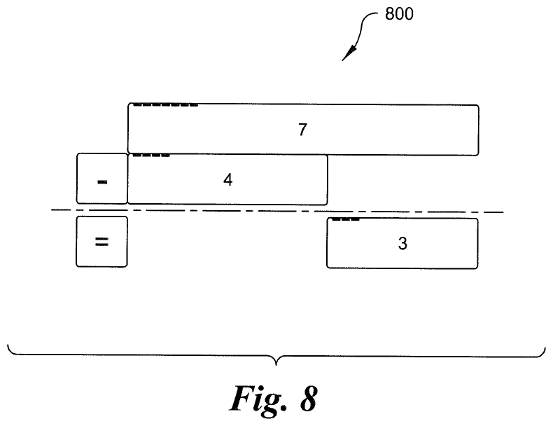

FIG. 8 illustrates the use of blocks for illustrating subtraction. In a top row of arrangement 800, a block 7 units in length is show. In the second row, a block 4 units in length, along with a block bearing a minus operator is shown, illustrating that the operation is to subtract 4 from 7. The bottom row shows a block 3 units in length, and a block having an equals operator. The child may readily see that the combined length of the 3-unit length block and the 4-unit length block is equal to the 7-unit length block, and may choose other blocks for further understanding of the subtraction concept. Further, the understanding of the operation symbols may be enhanced by arrangements such as arrangement 800.

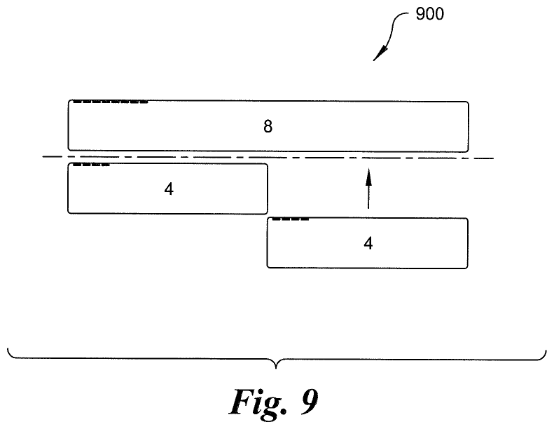

FIG. 9 similarly illustrates blocks according to an embodiment employed to teach subtraction, but without blocks bearing the operation symbols. The top row of arrangement 900 illustrates a block 8 units in length. The next row illustrates a block 4 units in length. The bottom row illustrates a block 4 units in length, and shows that the child may readily understand that the result of subtracting 4 from 8 results in 4. Additionally, the child may readily substitute blocks of differing lengths to better understand the subtraction process.

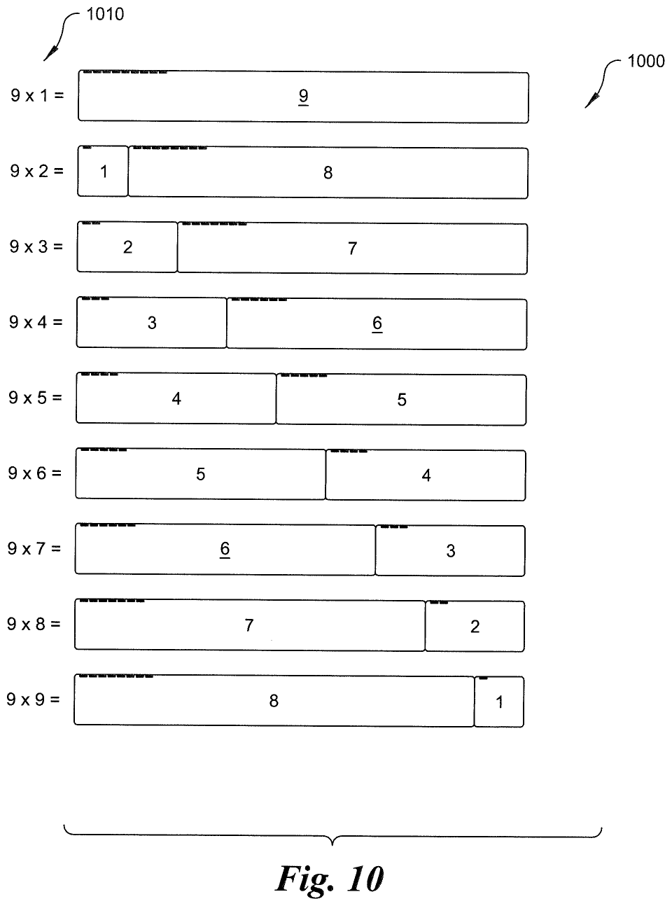

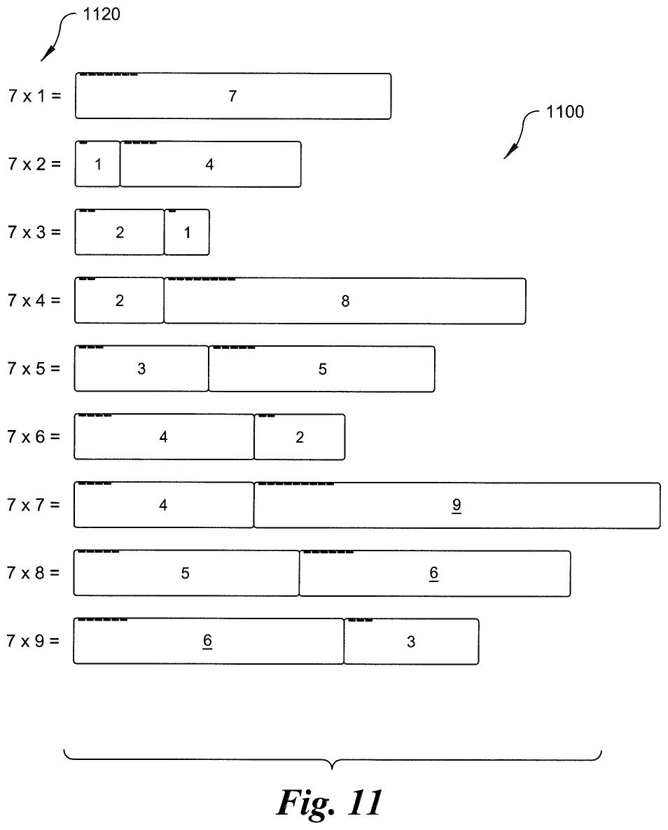

FIG. 10 illustrates blocks according to an embodiment employed to teach multiplication. Arrangement 1000 includes an arrangement of blocks representing the products of multiplication of 9 by each of the integers from 1 to 9. The column 1010 indicates the respective multiplication operation. Thus, a single block represents the product of 9 multiplied by 1. Blocks of length 1 and 8 represent the product of 9 multiplied by 2, and so on. The student will observe that each arrangement is 9 units in length, and thus can readily check whether an answer is accurate.

Similar arrangements may be employed to illustrate multiplication of other integers. For example, referring to FIG. 11, blocks are employed to teach multiplication by 7. Arrangement 1100 includes an arrangement of blocks representing the products of multiplication of 7 by each of the integers from 1 to 9. Students may be directed to note patterns that can assist with comprehension, such as a pattern of decrease in the length of the right-hand, or ones column, of 3 with each increase by 1 of the integer by which 7 is multiplied, and a repeating pattern of decrease in length of the combined blocks by 2 for two steps, and increase in length of the combined blocks by 7.

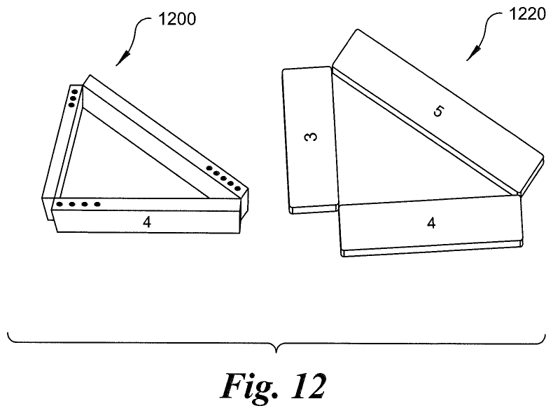

Referring to FIG. 12, illustrations are provided of blocks according to embodiments arranged as right triangles to illustrate the Pythagorean theorem. At 1200, blocks of lengths of 3 units and 4 units are arranged on their narrow sides to reflect the right-angled sides of a right triangle, and a block of length 5 units is arranged on its narrow side to reflect the hypotenuse of the right triangle. At 1220, blocks of lengths of 3 units and 4 units are arranged on their wide sides to reflect the right-angled sides of a right triangle, and a block of length 5 units is arranged on its wide side to reflect the hypotenuse of the right triangle. It will be appreciated that the blocks may be used to illustrate a wide variety of other geometric shapes.

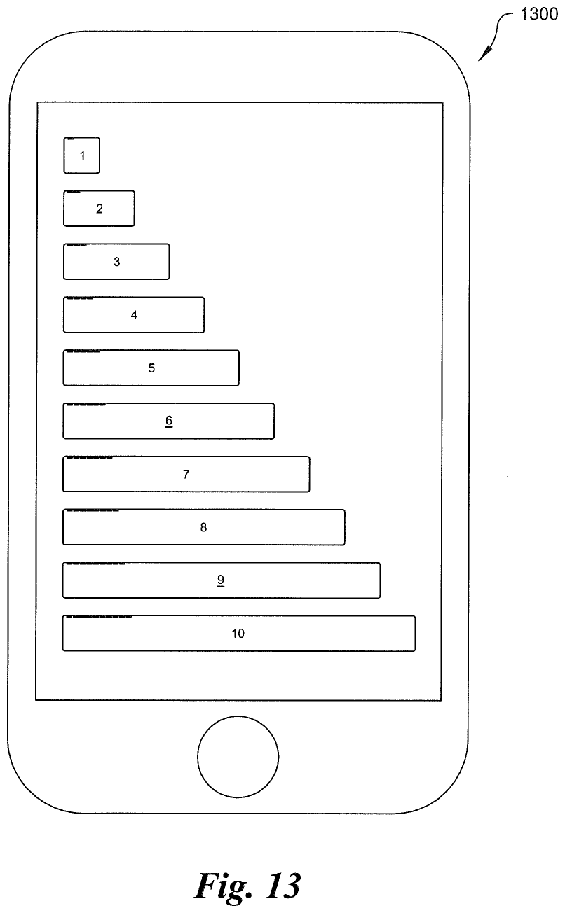

Referring to FIG. 13, a tablet computer is illustrated, showing a display provided by an application program of an interactive user interface displaying representations of blocks, which may be moved on the display responsive to user input. In an application program, blocks may be illustrated as maintaining constant relative dimensions to one another, and showing their numerals consistent with relative length in units. The application programs may provide that the images of respective blocks may not overlap. The application programs may provide that the images of respective blocks may automatically align side by side, end to end, or in arrangements to demonstrate geometric shapes, similar to the arrangements shown herein in any of the Figures. Application programs may be configured for display and manipulation of two-dimensional virtual blocks and three-dimensional virtual blocks. Application program features may include options to select and deselect blocks of particular lengths, or bearing particular operations, for display; to move blocks on the display, with images of blocks being able to be aligned with one another, or automatically aligning with one another; text and/or audio to prompt a user to manipulate blocks, to explain concepts, and the like. Such options may include selectable display elements, labeled with lengths and types of blocks, which, when selected, such as with a click of a pointing device or otherwise, cause the program to cause the processor to display the selected block. Similar display elements may be provided to remove blocks from a display, or the program may be configured to permit blocks to be deselected such as by placing a cursor of a pointing device on the block, clicking to provide a list of options, such as removing the block, duplicating the block, or other options, or immediately removing the block. By way of example, an application program may be configured to permit display of representations of blocks, and manipulation of representations of blocks, as illustrated in any of FIGS. 3-12 and 14A-14D. Application programs may support interaction via touch screens, movement of pointing devices such as mice and trackballs, keyboard interaction, and other interactions. Application programs may support interactions on a wide variety of devices, including tablet computers, smart phones, e-book readers, laptop computers, and desktop computers. Application programs may support manipulation using virtual reality systems and augmented reality systems, in which the blocks appear and may be manipulated as virtual physical objects. Application programs may be stored and executed by local processors and memory, or may be accessed in client-server mode, application service provider mode, or the like, via wired and wireless networks, including local networks such as LANs, and wider networks such as a Metropolitan Area Network (MAN), a Wide Area Network (WAN), a proprietary network, a Public Switched Telephone Network (PSTN), and the Internet, and via wireless connections such as Bluetooth protocol connections, wi-fi connections and cellular telephone networks. Application programs may be configured for interaction among multiple devices, so that multiple users may view and manipulate a shared screen display.

An application program, as used herein, may be a program, stored in a non-transitory computer readable medium, containing processor-executable instructions, and interacting with one or more processors and an operating system program. Examples of a non-transitory computer-readable medium include any appropriate information storage device, including magnetic storage devices (e.g., a hard disk drive), a magneto-optical medium, an optical medium such as a CD-ROM, a digital versatile disk (DVDs), or Blu-Ray disc (BD), and/or semiconductor memory devices, such as Dynamic Random Access Memory (D-RAM), Static RAM (S-RAM), or other RAM or a flash memory. As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine. In embodiments, processing speed may be enhanced by providing one or more co-processors, such as math co-processors, or other designated processors of a multi-processor chipset, to execute computational steps associated with generating and updating interactive displays of blocks as disclosed herein, while other functions of the computer system are carried out by a central processor.

In embodiments, a non-transitory computer-readable medium stores an application program including processor executable instructions, which instructions, when executed by the processor, cause the processor to display, on an interactive user interface, a plurality of blocks, at least some of the blocks having a length equal to a unit length multiplied by an integer from 1 to 10, and comprising, for each length equal to an integer from 1 to 10 multiplied by the unit length, at least one block; and responsive to user input, move the blocks on the interactive user interface, without change in dimensions of the blocks. Each of the blocks has indicia thereon corresponding to the integer defining the length of the block in unit lengths.

In embodiments, a computer system includes a memory and one or more processors. The one or more processors are configured by an application program stored in the memory to display, on an interactive user interface, a plurality of blocks, at least some of the blocks having a length equal to a unit length multiplied by an integer from 1 to 10, and comprising, for each length equal to an integer from 1 to 10 multiplied by the unit length, at least one block; and responsive to user input, move the blocks on the interactive user interface, without change in dimensions of the blocks. Each of the blocks has indicia thereon corresponding to the integer defining the length of the block in unit lengths.

In embodiments, a computer-implemented method includes displaying, by one or more processors, on an interactive user interface, a plurality of blocks, at least some of the blocks having a length equal to a unit length multiplied by an integer from 1 to 10, and comprising, for each length equal to an integer from 1 to 10 multiplied by the unit length, at least one block; receiving by the one or more processors user input; and responsive to the received user input, causing, by the one or more processors, the blocks to move on the interactive user interface, without change in dimensions of the blocks. Each of the blocks has indicia thereon corresponding to the integer defining the length of the block in unit lengths.

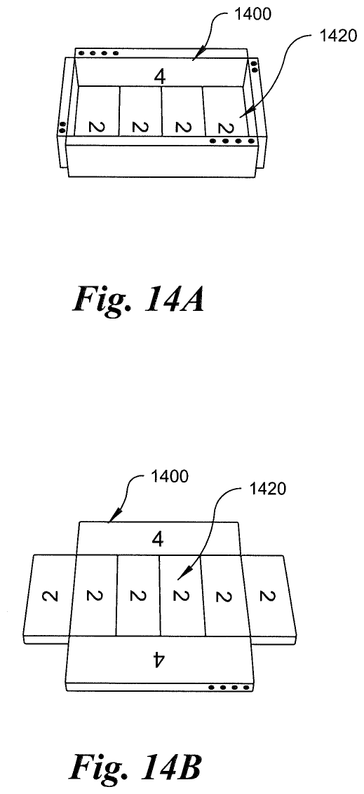

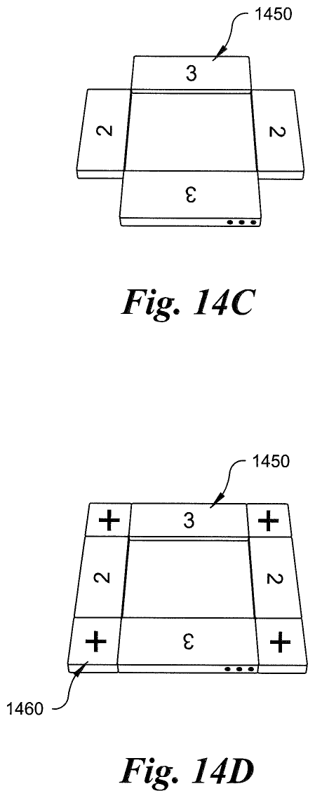

Referring to FIGS. 14A and 14B, there are shown arrangements of blocks for teaching geometric concepts. In FIG. 14A, four blocks 1400 of two different lengths, are arranged in a rectangle, on their narrow edges. In the illustrated embodiment, the blocks 1400 are of 4 units and 2 units in length, and blocks 1420 having a total length of 8 units, in this case by 4 blocks of 2 units in length, are shown within the blocks 1400, illustrating that the area within the rectangle is equal to the product of the lengths of two sides. In this and other embodiments, the blocks have a width of one unit, such that the area of each block is equal to the number of units, thereby facilitating the teaching of the determination of area of shapes.

In FIG. 14B, blocks 1400 and 1420 are also shown, but with blocks 1400 defining a rectangle arranged on their wide sides.

In FIG. 14C, four blocks 1450 of two different lengths are arranged in a rectangle, with their wide sides, to illustrate the perimeter of a rectangle that may be a rectangle having an area that may be determined by multiplication of lengths of the sides of the rectangle. In FIG. 14D, blocks 1450 are shown, further with blocks 1460 marked with addition operators/equals signs.

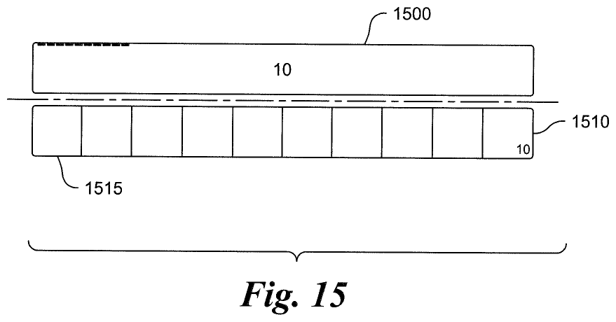

Referring to FIG. 15, blocks 1500 and 1510 are shown with their upper and lower surfaces, respective. Block 1510 shows that unit lengths are marked, so that the user may count, in this example, 10 marked units, such as unit 1515, to better grasp the meaning of the integer equal to the length of the block.

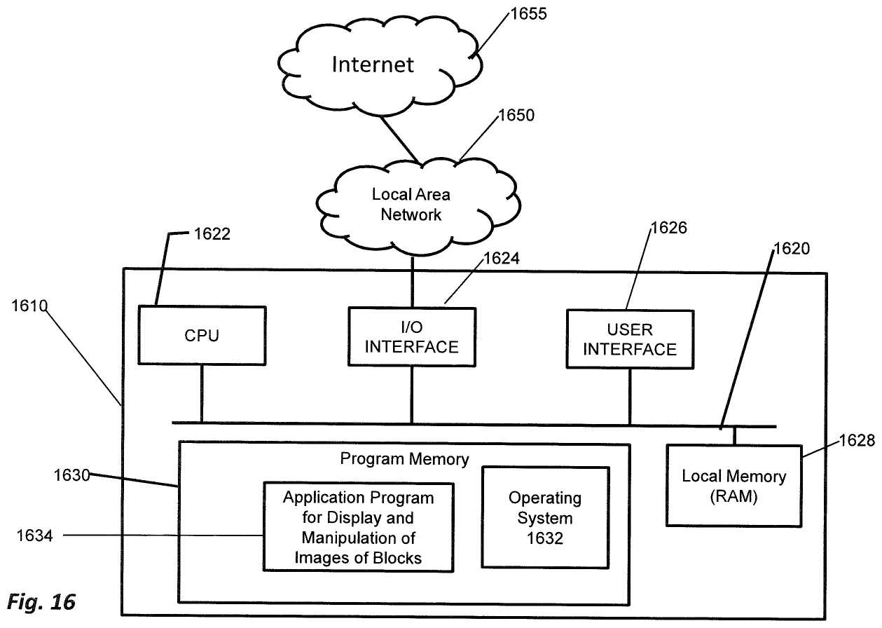

Referring to FIG. 16, there is shown an expanded block diagram of a computer architecture of an exemplary computer employed in some embodiments. Computer 1610 includes exemplary data bus 1620 providing communication among system components. One or more computer processors, designated by central processing unit (CPU) 1622, are in communication via data bus 1620 with components including program memory 1630, local memory 1628, user interface 1626, and input/output interface 1624. Program memory 1630 stores programs including an operating system (OS) 1632, which manages the computer hardware and provides common services for efficient execution of various logic circuitry including hardware, software and/or programs. Program memory 1630 further stores application software. The application software includes an application program 1634 to provide for display and manipulation of images of sets of blocks having labeling and relative dimensions as described herein, which includes computer-executable instructions to generate displays of suitable blocks, respond to manipulation of blocks via touchscreen, pointing device, keyboard or menus, and other functionality described herein. By way of example, such application program may cause the display shown in FIG. 13 to be displayed on a display or monitor of computer 1610. Program memory 1630 further may include a device communication management program, which includes computer-executable instructions to manage communications, particularly communications with other computer systems and resources. The processor 1622 (or CPU) carries out the instructions of computer programs, which operates and/or controls at least a portion of the functionality of the computer. Program instructions may be loaded into local memory 1628 for efficient and high-speed execution by CPU 1622. Programs may be arranged in one or more modules, and functionality of programs may be implemented in program code that may be arranged as one or more programs or modules, which need not be stored on a same memory device, or executed by a single CPU.

Computer 1610 further includes device input/output interface 1624, which interfaces computer 1610 with local area network 1650, or other network, such as a cellular telephone network to connect to Internet 1655, for example, to perform such functions as downloading of application software, and uploading of reports and results of operation of application software to servers and other systems for review by teachers, parents and others, to assess progress. Data communications may also be accomplished from and/or to peripheral devices and networks operatively coupled to the system. Local area network 1650 may further be coupled, via one or more intermediary communication devices, such as firewall systems and other access management systems (not shown), to network 1655, which may be or include the Internet, as well as other wired and/or wireless networks, to remote devices and remote systems.

Physical embodiments of blocks may be made of suitable materials to maintain their shape and dimensions and be non-toxic. By way of example, blocks may be rigid, and made of such materials as wood and rigid plastics. Corners of blocks may be beveled. Blocks may be flexible while still retaining their relative lengths, and thus may be made of elastic plastic materials, and synthetic and natural rubber, for example. Blocks may be unitary, and made of a single material, or may be assembled from parts of different materials. The identified materials are only exemplary.

Blocks may be solid or hollow. In embodiments, blocks may have surfaces that completely separate an interior space from the exterior, or may have openings through the surfaces to interior hollow spaces.

The size of blocks may be adapted to the dexterity of the age range for which the blocks are intended. For example, the unit length may be between one-quarter inch and four inches, and particularly between one inch and 3 inches, and may be 2 inches. The blocks may be one-eighth inch to four inches in thickness, or one quarter inch to one inch in thickness, and may have a thickness of one-half inch. The width of the blocks may be equal to the unit length, as illustrated, or may differ from the unit length.

Kits may include more than one block of each integral length from one unit to ten units, and may include additional blocks of the same or longer unit lengths. Kits may include both blocks of integral unit lengths and blocks illustrated with operation symbols.

Blocks may be adapted to bases other than base 10. Thus, the number of blocks may correspond to the number of integers in the base, and such blocks may be employed for developing facility in other bases.

In embodiments, the blocks according to embodiments of the present disclosure may be employed to enhance language literacy. For example, the numbers representing the lengths of blocks may be presented as spelled out, in one or more languages, on the blocks, as an alternative to, or in addition, to represented as numerals.

Blocks according to embodiments of the present disclosure may be employed to accommodate learners of varying styles and capabilities. For example, visually impaired learners may learn mathematical concepts, and may determine the numerals associated with the blocks using the tactile indicators. The use of blocks according to embodiments of the present disclosure may facilitate acquisition of mathematical concepts and other concepts by learners on the autism spectrum.

In embodiments, blocks according to embodiments of the present disclosure may be employed in lessons without other devices, or may be employed in combination with other techniques and devices as part of a learning system.

The embodiments described herein are exemplary, and other variations are feasible within the scope of the disclosure.

What is claimed is:

1. A kit defining an educational apparatus, comprising:
a plurality of blocks, at least some of the blocks having a length equal to a unit length multiplied by an integer from 1 to 10, and comprising, for each length equal to an integer from 1 to 10 multiplied by the unit length, at least one block;
wherein each of the blocks has indicia thereon corresponding to the integer defining the length of the block in unit lengths.

2. The kit of claim 1, wherein each of the blocks is substantially a rectangular prism.

3. The kit of claim 2, wherein each of the blocks is equal to each of the other blocks in dimensions other than length.

4. The kit of claim 1, further comprising a plurality of blocks, each bearing one of the addition, subtraction, greater than, less than, and equality operators.

5. The kit of claim 1, wherein the indicia include at least one of visible and tactile indicia.

6. The kit of claim 5, wherein the indicia include both visible and tactile indicia on each block.

7. A non-transitory computer-readable medium storing an application program including processor executable instructions, which instructions, when executed by the processor, cause the processor to:
display, on an interactive user interface, representations of a plurality of blocks, at least some of the blocks having a length equal to a unit length multiplied by an integer from 1 to 10, and comprising, for each length equal to an integer from 1 to 10 multiplied by the unit length, at least one block; and
responsive to user input, move the representations of the blocks on the interactive user interface while maintaining constant relative dimensions;
wherein each of the blocks has indicia thereon corresponding to the integer defining the length of the block in unit lengths.

8. The non-transitory computer-readable medium of claim 7, wherein the instructions, when executed by the processor, further cause the processor to display user options for selection and deselection of blocks of particular lengths, and responsive to user selection of a block of a particular length, display a representation of the selected block of the particular length.

9. The non-transitory computer-readable medium of claim 7, wherein the instructions, when executed by the processor, further cause the processor to automatically align blocks.

10. The non-transitory computer-readable medium of claim 7, wherein the instructions, when executed by the processor, cause the processor to display the blocks as two-dimensional objects.

11. The non-transitory computer-readable medium of claim 7, wherein the instructions, when executed by the processor, cause the processor to automatically align images of blocks adjacent to one another.
